(19) United States
(12) Patent Application Publication
(10) Pub. No.: US 2026/0134505 A1
(43) Pub. Date: May 14, 2026

(54) POINT CLOUD DATA PROCESSING METHOD AND APPARATUS, DEVICE, MEDIUM, AND COMPUTER PROGRAM PRODUCT

(71) Applicant: Tencent Technology (Shenzhen) Company Limited, Shenzhen (CN)

(72) Inventors: Ying SHI, Shenzhen (CN); Yiming ZENG, Shenzhen (CN)

(21) Appl. No.: 19/445,218

(22) Filed: Jan. 9, 2026

Related U.S. Application Data
(63) Continuation of application No. PCT/CN2024/112653, filed on Aug. 16, 2024.

(30) Foreign Application Priority Data
Oct. 26, 2023 (CN) 202311418775.6

(51) Int. Cl. G06T 3/4007; G06T 7/50; G06T 7/73; G06T 15/00

(52) U.S. Cl. CPC G06T 3/4007; G06T 7/50; G06T 7/73; G06T 15/00; G06T 2200/04; G06T 2207/10028; G06T 2210/56

(57) ABSTRACT

A point cloud data processing method is performed by an electronic device, and the method includes: obtaining, at a first resolution, original point cloud data including a plurality of feature points in a three-dimensional scene and their spatial position information; respectively mapping the feature points to pixel points in a depth image at the first resolution based on their spatial position information; performing interpolation on the depth image based on the pixel values of the mapped pixel points in the depth image, to obtain an extended depth image at a second resolution; performing spatial position transformation on interpolated pixel points in the extended depth image, to obtain spatial position information of target feature points in the three-dimensional scene; and determining target point cloud data at the second resolution based on the spatial position information of the target feature point and the original point cloud data.

### CROSS-REFERENCE TO RELATED APPLICATIONS

This application is a continuation application of PCT Patent Application No. PCT/CN2024/112653, entitled “POINT CLOUD DATA PROCESSING METHOD AND APPARATUS, DEVICE, MEDIUM, AND COMPUTER PROGRAM PRODUCT” filed on Aug. 16, 2024, which claims priority to Chinese Patent Application No. 2023114187756, entitled “POINT CLOUD DATA PROCESSING METHOD AND RELATED DEVICE” filed on Oct. 26, 2023, both of which are incorporated herein by reference in their entirety.

### FIELD OF THE TECHNOLOGY

This application relates to the field of computer technologies, and in particular, to a point cloud data processing method and apparatus, a device, a medium, and a computer program product.

### BACKGROUND OF THE DISCLOSURE

Point cloud data is a point data set in a specific coordinate system obtained by scanning an object or a scene by using a measurement instrument. In an exemplary application scenario, a three-dimensional laser radar scanner may be used to scan an object or a scene to obtain point cloud data, and the point cloud data may be configured for modeling a corresponding object or scene, or analyzing and processing a corresponding object or scene. In actual application, due to limitations of performance of the measurement instrument, original point cloud data obtained through scanning by the measurement instrument may be sparse, in other words, has a low resolution. Consequently, an ideal effect is not easy to be obtained when modeling or analysis and processing are performed on an object or a scene based on the original point cloud data. Therefore, the resolution of the point cloud data needs to be increased, and dense point cloud data can improve accuracy of modeling or analysis.

In an existing related art, three-dimensional point cloud data is usually upsampled to denser point cloud data by using a deep learning model. However, point distribution obtained through the method cannot fully describe a shape of an object, and many noise also exist around a target, which is not beneficial to improvement of accuracy of object detection. In addition, in the method, a large amount of training data is needed to help the deep learning model to reconstruct data, resulting in a large quantity of model parameters and a large amount of calculation.

### SUMMARY

Embodiments of this application provide a point cloud data processing method and apparatus, a device, a medium, and a computer program product.

An embodiment of this application provides a point cloud data processing method, performed by an electronic device and the method including:
obtaining original point cloud data at a first resolution, the original point cloud data comprising a plurality of feature points obtained by sampling a three-dimensional scene and spatial position information of the feature points in the three-dimensional scene;
respectively mapping the feature points in the original point cloud data to pixel points in a depth image at the first resolution based on the spatial position information of the feature points, wherein pixel values of the mapped pixel points represents depth information of the feature points;
performing interpolation on the depth image based on the pixel values of the mapped pixel points in the depth image, to obtain an extended depth image at a second resolution;
performing spatial position transformation on interpolated pixel points in the extended depth image, to obtain spatial position information of target feature points in the three-dimensional scene that corresponds to the interpolated pixel point; and
determining target point cloud data at the second resolution based on the spatial position information of the target feature point and the original point cloud data.

An embodiment of this application provides an electronic device, including a processor and a memory, the memory having a plurality of instructions stored therein, and the instructions being loaded by the processor, to perform operations of the point cloud data processing method provided in this embodiment of this application.

An embodiment of this application further provides a non-transitory computer-readable storage medium, having a computer program stored therein, the computer programs, when executed by a processor, implementing operations of the point cloud data processing method provided in this embodiment of this application.

Details of one or more embodiments of this application are provided in the following accompanying drawings and descriptions. Other features, objectives, and advantages of this application become apparent from the specification, the accompanying drawings, and the claims.

### BRIEF DESCRIPTION OF THE DRAWINGS

To describe the technical solutions in embodiments of this application or conventional technologies more clearly, the following briefly describes the accompanying drawings for describing embodiments or the conventional technologies. Apparently, the accompanying drawings in the following descriptions show merely embodiments of this application, and a person of ordinary skill in the art may still obtain other accompanying drawings from disclosed accompanying drawings without creative efforts.

FIG. 1 is a schematic diagram of a scenario of a point cloud data processing method according to an embodiment of this application.

FIG. 2 is a flowchart of a point cloud data processing method according to an embodiment of this application.

FIG. 3 is a description diagram of a point cloud data processing method according to an embodiment of this application.

FIG. 4 is another description diagram of a point cloud data processing method according to an embodiment of this application.

FIG. 5 is another description diagram of a point cloud data processing method according to an embodiment of this application.

FIG. 6 is another description diagram of a point cloud data processing method according to an embodiment of this application.

FIG. 7 is another description diagram of a point cloud data processing method according to an embodiment of this application.

FIG. 8 is another flowchart of a point cloud data processing method according to an embodiment of this application.

FIG. 9 is another flowchart of a point cloud data processing method according to an embodiment of this application.

FIG. 10 is a schematic diagram of a structure of a point cloud data processing apparatus according to an embodiment of this application.

FIG. 11 is a schematic diagram of a structure of an electronic device according to an embodiment of this application.

### DESCRIPTION OF EMBODIMENTS

The technical solutions in embodiments of this application are clearly and completely described below with reference to the accompanying drawings in embodiments of this application. Apparently, the described embodiments are merely some rather than all of embodiments of this application. All other embodiments obtained by a person of ordinary skill in the art based on embodiments of this application without creative efforts shall fall within the protection scope of this application.

Embodiments of this application provide a point cloud data processing method and apparatus, a device, a medium, and a computer program product. The point cloud data processing apparatus may be specifically integrated in an electronic device. The electronic device may be a terminal, a server, or another device.

The point cloud data processing method in this embodiment may be performed on the terminal, may be performed on the server, or may be performed by the terminal and the server together. The foregoing examples are not to be construed as limiting this application.

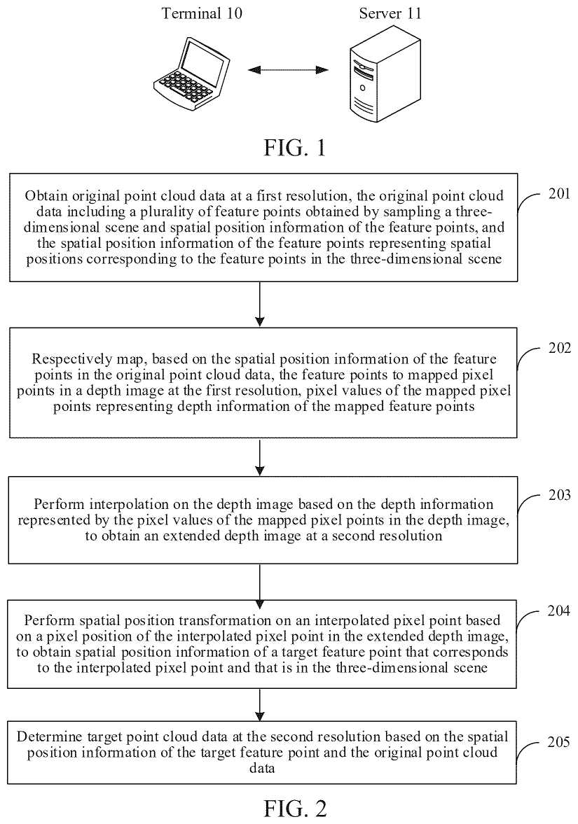

As shown in FIG. 1, an example in which the point cloud data processing method is performed by the terminal and the server together is used. A point cloud data processing system provided in this embodiment of this application includes a terminal 10, a server 11, and the like. The terminal 10 is connected to the server 11 through a network, for example, through a wired or wireless network. The point cloud data processing apparatus may be integrated in the server.

The server 11 may be configured to receive original point cloud data that is at a first resolution and that is sent by the terminal 10, the original point cloud data including a plurality of feature points obtained by sampling a three-dimensional scene and spatial position information of the feature points, and the spatial position information of the feature points representing spatial positions corresponding to the feature points in the three-dimensional scene; respectively map, based on the spatial position information of the feature points in the original point cloud data, the feature points to mapped pixel points in a depth image at the first resolution, pixel values of the mapped pixel points representing depth information of the mapped feature points; perform interpolation on the depth image based on the depth information represented by the pixel values of the mapped pixel points in the depth image, to obtain an extended depth image at a second resolution; perform spatial position transformation on an interpolated pixel point based on a pixel position of the interpolated pixel point in the extended depth image, to obtain spatial position information of a target feature point that corresponds to the interpolated pixel point and that is in the three-dimensional scene; and determine target point cloud data at the second resolution based on the spatial position information of the target feature point and the original point cloud data. The server 11 may be an independent physical server, may be a server cluster or distributed system including a plurality of physical servers, or may be a cloud server that provides a cloud computing service.

The terminal 10 may be configured to collect original point cloud data at a first resolution, and send the original point cloud data to the server 11, the original point cloud data including a plurality of feature points obtained by sampling a three-dimensional scene and spatial position information of the feature points, and the spatial position information of the feature points representing spatial positions corresponding to the feature points in the three-dimensional scene. The terminal 10 may include a mobile phone, an in-vehicle terminal, an aircraft, a tablet computer, a notebook computer, or a personal computer (PC), and the like. A client may be further provided on the terminal 10. The client may be an application client, a browser client, or the like.

The point cloud data processing method provided in this embodiment of this application relates to the fields of transportation and mapping.

Detailed descriptions are separately provided below. A description order of the following embodiments is not used as a limitation on the priority order of embodiments.

This embodiment is described from a perspective of the point cloud data processing apparatus. The point cloud data processing apparatus may be specifically integrated into an electronic device. The electronic device may be a server, a terminal, or another device.

In a specific implementation of this application, related data such as user information is involved. When the foregoing embodiments of this application are applied to a specific product or technology, a permission or consent of a user is needed, and collection, use, and processing of the related data need to comply with relevant laws, regulations, and standards of relevant countries and regions.

As shown in FIG. 2, a specific procedure of the point cloud data processing method may be as follows.

201: Obtain original point cloud data at a first resolution, the original point cloud data including a plurality of feature points obtained by sampling a three-dimensional scene and spatial position information of the feature points, and the spatial position information of the feature points representing spatial positions corresponding to the feature points in the three-dimensional scene.

The original point cloud data is a point data set in a specific coordinate system obtained by scanning the three-dimensional scene by using a measurement instrument. The measurement instrument may be a laser radar. The original point cloud data includes a plurality of sampling points, and each sampling point is a feature point. The three-dimensional scene may be an environment in which sampling is performed, and may be specifically a spatial range in a real environment. Specifically, point cloud data is a massive point set that represents spatial distribution and a surface feature of a target object in the same spatial reference system.

Specifically, the feature point is obtained through sampling of a plurality of groups of lasers simultaneously emitted by a rotating laser radar to the three-dimensional scene along different vertical angles based on a horizontal azimuth angle resolution. Different groups of lasers correspond to different vertical channels, in other words, correspond to different vertical angles.

In this embodiment, the first resolution may include a horizontal azimuth angle resolution and a vertical angle resolution that correspond to used laser radar hardware. An azimuth angle is an angle of a geographical location or an object relative to a specific reference point. The azimuth angle usually uses a due north direction as a reference, is measured in a clockwise direction, and ranges from 0° to 360°. For example, when an azimuth angle of an object is 0°, it indicates that the object is in a due north direction; when the azimuth angle is 90°, it indicates that the object is in a due east direction; when the azimuth angle is 180°, it indicates that the object is in a due south direction; and when the azimuth angle is 270°, it indicates that the object is in a due west direction.

In some embodiments, the spatial position information of the feature point may be specifically three-dimensional (3D) position information, which may include specific coordinate values of the feature point on an x-axis, a y-axis, and a z-axis in a three-dimensional coordinate system. Specifically, the spatial position information of the feature point may further include information such as a horizontal scanning angle and a vertical scanning angle of the laser radar corresponding to the feature point.

202: Respectively map, based on the spatial position information of the feature points in the original point cloud data, the feature points to mapped pixel points in a depth image at the first resolution, pixel values of the mapped pixel points representing depth information of the mapped feature points.

The depth information of the feature point may be a distance between the feature point and the measurement instrument, and the distance between the feature point and the measurement instrument is specifically a distance between the feature point and the laser radar. The depth information of the feature point may be determined based on the spatial position information of the feature point.

In some embodiments, the feature points may be mapped to a preset image, to obtain the depth image at the first resolution. The preset image may be a blank image, and pixel values of pixel points in the blank image are zero. A row of the preset image may represent a horizontal azimuth angle (that is, a horizontal angle), and a column represents a vertical angle.

For the feature points in the original point cloud data, position transformation may be performed on the spatial position information of the feature points, to convert the three-dimensional coordinates into two-dimensional coordinates, so as to map the feature points to the preset image. Through the position transformation, the unordered three-dimensional point cloud data may be projected on the ordered depth image. The feature points in the original point cloud data are in one-to-one correspondence with the mapped pixel points in the depth image.

The depth image is an image in which point cloud data in three-dimensional space is mapped to a two-dimensional plane, and may also be referred to as a range image. A pixel value of a pixel point in the image represents depth information of a corresponding point. The pixel point in the depth image may have one or more image channels (Ch). One image channel may correspond to one type of information, and a quantity of image channels is related to a quantity of types of information. In a specific embodiment, the pixel point in the depth image may have a depth channel and an attribute channel. The depth channel is a distance measurement channel, and the attribute channel may include an intensity channel, a color channel, or the like. A pixel value corresponding to the pixel point in the distance measurement channel indicates a distance between a corresponding feature point and the laser radar. A pixel value corresponding to the pixel point in the intensity channel indicates an intensity value of a laser beam point corresponding to the corresponding feature point. A pixel value corresponding to the pixel point in the color channel indicates color information corresponding to the corresponding feature point.

In a specific scenario, the original point cloud data may be a structure of a list of three-dimensional positions and laser beam point intensity values that are arranged in a laser diode scanning order, and the list may vary depending on a laser radar model. A quantity of dimensions of the original point cloud data may be represented by N*D. N represents a total number of laser beam points. D represents a quantity of features of the laser beam points, for example, three-dimensional Cartesian coordinates and an intensity value. The original point cloud data is in an unordered form in spatial coordinates. Usually, the original point cloud data is three-dimensional space or space of a higher dimension that is formed by sparse and unordered data points, which increases interpolation complexity. In this application, the original point cloud data on is projected on the depth image, so that complexity of processing such unordered data can be reduced. The depth image may be sorted in space by using 2D coordinates of a horizontal scanning angle and a vertical scanning angle, as shown in FIG. 3.

In some embodiments, a size of the depth image may be H*V*C. H is a horizontal azimuth angle (α). V is a laser radar vertical angle (specifically, may alternatively be a quantity of laser radar vertical channels). C may include a distance measurement channel and an intensity channel. Specifically, a quantity of 3D points obtained through single scanning of the rotating laser radar is determined based on a quantity of vertical channels, a vertical resolution (Vres), a horizontal field of view (FOV), and a horizontal angle resolution (Hres).

Specifically, in this embodiment, the three-dimensional point cloud data is projected on the range image in the azimuth angle and the vertical angle, and position transformation may be performed by using a transformation equation in spherical coordinates, as shown in Formula (1), Formula (2), and Formula (3) below:

$$R = \sqrt{{x}^{2} + {y}^{2} + {z}^{2}} \qquad ( 1 )$$

$$α = arctan ( y , x ) \qquad ( 2 )$$

$$ω = arc tan ( z , \sqrt{{x}^{2} + {y}^{2}} ) \qquad ( 3 )$$

As shown in FIG. 3, in a space rectangular coordinate system, a laser radar is used as a circle center; x, y, and z are respectively coordinate values of a feature point on a horizontal axis, a longitudinal axis, and a vertical axis in the space rectangular coordinate system; R represents a distance between the feature point and the laser radar, that is, depth information of the feature point; a represents a horizontal azimuth angle; and @ represents a vertical angle.

Specifically, a dimension of the 3D point cloud data generated by the laser radar LiDAR (HDL-64E) is 2048*64*4 Ch (X-Ch, Y-Ch, Z-Ch, Intensity-Ch), and may be converted into a range image of 2048*64*2 Ch (α-Ch, ω-Ch). Ch represents a channel. X-Ch, Y-Ch, Z-Ch, and Intensity-Ch respectively represent X, Y, Z, and an intensity value channel. α-Ch and @-Ch are each a channel of a converted range image, and respectively represent a horizontal angle and a vertical angle.

The “depth image” in this application is different from an image in a daily sense, and corresponds to a picture that is visually invisible. Specifically, the depth image in this application represents information in an original point cloud by using a two-dimensional pixel array and pixel values of pixels, to facilitate subsequent processing.

203: Perform interpolation on the depth image based on the depth information represented by the pixel values of the mapped pixel points in the depth image, to obtain an extended depth image at a second resolution.

The second resolution is greater than the first resolution. The second resolution may include a horizontal azimuth angle resolution and a vertical angle resolution. Specifically, in this embodiment, upsampling (that is, interpolation) may be performed in a horizontal direction and an elevation direction, or upsampling may be performed in only one of the horizontal direction and the elevation direction. For example, upsampling may be performed only in the elevation direction, to increase density of a vertical angle of a laser radar channel. In this way, in comparison with the first resolution, for the second resolution, only the vertical angle resolution changes, and the horizontal azimuth angle resolution remains unchanged. For another example, upsampling may be performed only in the horizontal direction. In this way, in comparison with the first resolution, for the second resolution, only the horizontal azimuth angle resolution changes, and the vertical angle resolution remains unchanged.

The extended depth image is an interpolated depth image.

In this embodiment, the operation of “performing interpolation on the depth image based on the depth information represented by the pixel values of the mapped pixel points in the depth image, to obtain an extended depth image at a second resolution” may include the following operations:
determining a pixel position of a to-be-interpolated pixel point in the depth image, and determining adjacent pixel points of the to-be-interpolated pixel point from the mapped pixel points based on the mapped pixel points and the pixel position of the to-be-interpolated pixel point in the depth image; and
fusing depth information represented by pixel values of the adjacent pixel points, to determine depth information of the to-be-interpolated pixel point, and obtain the extended depth image at the second resolution.

After the depth information of the to-be-interpolated pixel point is determined, the depth information may be interpolated to the to-be-interpolated pixel point in the depth image, to obtain an interpolated pixel point.

The depth information represented by the pixel values of the adjacent pixel points may be fused in a plurality of manners, for example, weighted fusion.

In some embodiments, a mapped pixel point of which a pixel distance to the to-be-interpolated pixel point is less than a preset distance may be determined as an adjacent pixel point of the to-be-interpolated pixel point. The pixel distance is a distance between two pixel points in the depth image. In some other embodiments, adjacent pixel points of a specific to-be-interpolated pixel point may be k mapped pixel points that are closest to the to-be-interpolated pixel point in terms of a pixel distance and that have depth information. k may be set based on an actual situation, for example, may be set to 6.

Specifically, a row of the depth image represents a horizontal azimuth angle, a column represents a vertical angle. Mapped pixel points in the same row have different horizontal azimuth angles and the same vertical angle. Mapped pixel points in the same column have the same horizontal azimuth angles and different vertical angle. If upsampling is performed only in the elevation direction, in comparison with the depth image, in the extended depth image, a quantity of rows of the image increases, and a quantity of columns of the image remains unchanged. Otherwise, if upsampling is performed only in the horizontal direction, in comparison with the depth image, in the extended depth image, a quantity of columns of the image increases, and a quantity of rows of the image remains unchanged.

In this embodiment, the operation of “fusing depth information represented by pixel values of the adjacent pixel points, to determine depth information of the to-be-interpolated pixel point” may include the following operations:
determining pixel distances between the adjacent pixel points and the to-be-interpolated pixel point based on pixel positions of the adjacent pixel points and the pixel position of the to-be-interpolated pixel point in the depth image;
determining weight information of the adjacent pixel points based on the pixel distances; and
fusing, based on the weight information, the depth information represented by the pixel values of the adjacent pixel points, to determine the depth information of the to-be-interpolated pixel point.

A longer pixel distance indicates smaller weight information of the adjacent pixel points. Otherwise, a shorter pixel distance indicates greater weight information of the adjacent pixel points.

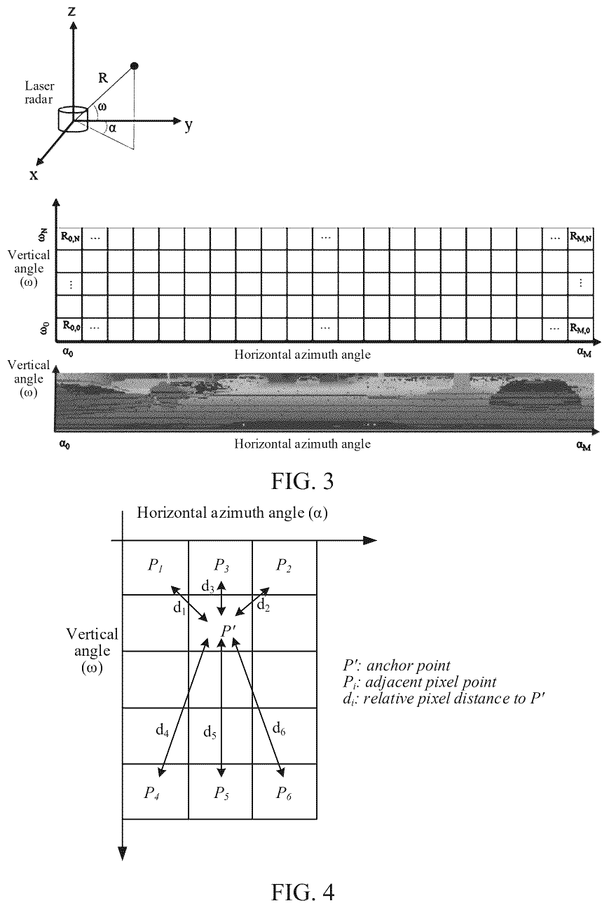

In a specific example, the depth image is a range image, and upsampling may be performed on the depth image by using a pixel distance weighted interpolation method, to obtain an interpolated extended depth image. Specifically, in the method, six adjacent pixel points that are around an anchor point (that is, the to-be-interpolated pixel point) in the range image and that are obtained through light detection and ranging (LiDAR) are used, and weighted interpolation is performed on the six adjacent pixel points based on relative pixel distances between the six adjacent pixel points and the anchor point. FIG. 4 is a corresponding description diagram of performing interpolation by using a weighted sum of adjacent pixel points. Six interpolated neighborhood pixel points are marked as P₁ to P₆ from an upper left corner pixel point. Blank grids represent blank areas without a laser radar point. Depth information (specifically, a distance between a corresponding feature point and the laser radar) of a to-be-interpolated pixel point P′ is obtained based on a weighted sum of distances between adjacent points with an attenuation factor, as shown in Formula (4) and Formula (5):

$${W}_{i} = {e}^{- 0.5 {d}_{i}} \qquad ( 4 )$$

$${P}^{′} = \frac{{\sum }_{i = 1}^{6} {W}_{i} {P}_{i}}{{\sum }_{i = 1}^{6} {W}_{i}} \qquad ( 5 )$$

Pᵢ represents an adjacent pixel point. A pixel value corresponding to Pᵢ represents a distance value between a corresponding feature point and the laser radar. Wᵢ represents weight information of Pᵢ. dᵢ represents a pixel distance between Pᵢ and P′.

In this embodiment, before the operation of “fusing, based on the weight information, the depth information represented by the pixel values of the adjacent pixel points, to determine the depth information of the to-be-interpolated pixel point”, the point cloud data processing method may further include the following operation:
determining the mapped pixel points as abnormal pixel points when depth information corresponding to the mapped pixel points does not satisfy a preset depth condition.

The operation of “fusing, based on the weight information, the depth information represented by the pixel values of the adjacent pixel points, to determine the depth information of the to-be-interpolated pixel point” may include the following operations:
detecting whether the adjacent pixel points are abnormal pixel points, to obtain a detection result; and
fusing, based on the detection result and the weight information, the depth information represented by the pixel values of the adjacent pixel points, to determine depth information of the to-be-interpolated pixel point.

The preset depth condition may be set based on an actual situation. For example, the preset depth condition may be set as that when a depth value corresponding to depth information of a pixel point is within a preset range, the pixel point is a non-abnormal pixel point. An excessively large or excessively small depth value usually indicates an outlier point. In this embodiment, anomaly detection may be performed on the adjacent pixel points, to reduce negative impact of an abnormal pixel point (that is, the outlier point) during interpolation.

In this embodiment, the operation of “fusing, based on the detection result and the weight information, the depth information represented by the pixel values of the adjacent pixel points, to determine depth information of the to-be-interpolated pixel point” may include the following operations:
setting weight adjustment coefficients of the adjacent pixel points based on the detection result;
updating the weight information of the adjacent pixel points based on the weight adjustment coefficients; and
fusing, based on updated weight information, the depth information represented by the pixel values of the adjacent pixel points, to determine the depth information of the to-be-interpolated pixel point.

When it is detected that an adjacent pixel point is an abnormal pixel point, a weight adjustment coefficient of the adjacent pixel point may be set to 0, to reduce impact of the abnormal pixel point. When it is detected that the adjacent pixel point is not an abnormal pixel point, the weight adjustment coefficient of the adjacent pixel point may be set to 1.

In some embodiments, weight adjustment coefficients and the weight information of the adjacent pixel points may be fused to update the weight information of the adjacent pixel points. A fusion manner may be multiplication or the like.

In this embodiment, the operation of “determining weight information of the adjacent pixel points based on the pixel distances” may include the following operations:
determining first weight information of the adjacent pixel points based on the pixel distances;
comparing the depth information represented by the pixel values of the adjacent pixel points and reference depth information, to determine relative depth information corresponding to the adjacent pixel points;
determining second weight information of the adjacent pixel points based on the relative depth information; and
fusing the first weight information and the second weight information, to obtain the weight information of the adjacent pixel points.

The first weight information and the second weight information are fused in a plurality of manners, which is not limited in this embodiment. For example, a fusion manner may be multiplication or the like.

The reference depth information may be set based on an actual situation.

In this embodiment, the operation of “comparing the depth information represented by the pixel values of the adjacent pixel points and reference depth information, to determine the relative depth information corresponding to the adjacent pixel points” may include the following operations:
selecting, based on a magnitude of the depth information represented by the pixel values of the adjacent pixel points, the reference depth information from the depth information represented by the pixel values of the adjacent pixel points; and
comparing the depth information represented by the pixel values of the adjacent pixel points and the reference depth information, to determine the relative depth information corresponding to the adjacent pixel points.

In some embodiments, depth information with a minimum depth value may be selected from the depth information of the adjacent pixel points of the to-be-interpolated pixel point as the reference depth information.

Comparing the depth information represented by the pixel values of the adjacent pixel points and the reference depth information may be specifically that a difference operation is performed on the depth information represented by the pixel values of the adjacent pixel points and the reference depth information, and obtained differences are the relative depth information corresponding to the adjacent pixel points.

In a specific example, the depth image is a range image, and upsampling may be performed on the depth image by using a pixel distance and range weighted interpolation method, to obtain an interpolated extended depth image. Specifically, each weight Wᵢ may be re-adjusted based on a relative depth range between the adjacent pixel points, to enhance upsampling. The relative depth range between the adjacent pixel points is specifically a difference between distances between two pixel points and the laser radar. A depth (a distance to the laser radar) of a pixel point being closer to a reference depth (specifically, the reference depth information) indicates a greater weight provided in interpolation. This is similar to assuming that adjacent pixel points that are close to each other are likely to be projected on the same object. In addition, in a process of performing weighted sum, an outlier point (that is, an abnormal pixel point) in the adjacent pixel points may be skipped by using a coefficient sᵢ. The outlier point may be specifically a pixel point of which depth information corresponds to a depth value of zero or far greater than a preset threshold. For the outlier point, a value of the coefficient sᵢ is 0. Otherwise, the value of the coefficient sᵢ is 1. Corrected interpolation equations are shown in Formula (6) and Formula (7):

$${P}^{′} = \frac{{\sum }_{i = 1}^{6} {s}_{i} {W}_{i} {P}_{i}}{{\sum }_{i = 1}^{6} {s}_{i} {W}_{i}} \qquad ( 6 )$$

$${W}_{i} = {e}^{- 0.5 {d}_{i}} \cdot ( \frac{2}{1 + {e}^{( {R}_{i} - {R}_{min} )}} ) \qquad ( 7 )$$

sᵢ is the weight adjustment coefficient in the foregoing embodiment. Rᵢ is a distance value between an ith adjacent pixel point and the laser radar. Rₘᵢₙ is a minimum distance value in distance information of the adjacent pixel points of the to-be-interpolated pixel point. Wᵢ is the weight information of the adjacent pixel point. e^{-0.5d}^{ᵢ} is specifically the first weight information in the foregoing embodiment.

$$( \frac{2}{1 + {e}^{( {R}_{i} - {R}_{min} )}} )$$

is specifically the second weight information in the foregoing embodiment. Rᵢ−Rₘᵢₙ is the relative depth information in the foregoing embodiment.

Upsampling is performed on the depth image by using the foregoing pixel distance and range weighted interpolation method, so that impact of the outlier point can be reduced to the greatest extent, to improve robustness of the interpolation method.

204: Perform spatial position transformation on an interpolated pixel point based on a pixel position of the interpolated pixel point in the extended depth image, to obtain spatial position information of a target feature point that corresponds to the interpolated pixel point and that is in the three-dimensional scene.

The pixel position of the interpolated pixel point in the extended depth image may include a horizontal azimuth angle and a vertical angle. The spatial position information of the target feature point that corresponds to the interpolated pixel point and that is in the three-dimensional scene may be three-dimensional position information. The three-dimensional position information may be specific coordinate values of an x-axis, a y-axis, and a z-axis in a three-dimensional coordinate system.

In this embodiment, the operation of “performing spatial position transformation on an interpolated pixel point based on a pixel position of the interpolated pixel point in the extended depth image, to obtain spatial position information of a target feature point that corresponds to the interpolated pixel point and that is in the three-dimensional scene” may include the following operations:
determining, based on the pixel position of the interpolated pixel point in the extended depth image, a horizontal azimuth angle and a vertical angle that correspond to the interpolated pixel point; and performing spatial position transformation on the interpolated pixel point
based on the depth information, the horizontal azimuth angle, and the vertical angle of the interpolated pixel point, to obtain the spatial position information of the target feature point that corresponds to the interpolated pixel point and that is in the three-dimensional scene.

The depth information of the interpolated pixel point may specifically represent a distance value between a corresponding feature point and a target measurement instrument (specifically, the laser radar).

Specifically, in this embodiment, after the interpolated extended depth image is obtained, spatial position transformation may be performed on the obtained interpolated pixel point, to be specific, two-dimensional data is converted into three-dimensional data. Specifically, a two-dimensional range image may be converted into a high-dimensional range image with 4-Ch Cartesian coordinates (x, y, z) and an intensity value. Values of x, y, and z may be obtained from a horizontal azimuth angle, an elevation angle (specifically, a vertical angle), and a distance value r, as shown in Formula (8), Formula (9), and Formula (10):

$$x = r cos ω cos α \qquad ( 8 )$$

$$y = r cos ω sin α \qquad ( 9 )$$

$$z = r sin ω \qquad ( 10 )$$

An azimuth angle (α) and an elevation angle (ω) represent coordinates of the interpolated pixel point in the two-dimensional range image. r represents a value of a distance between a corresponding pixel point and the laser radar, that is, the depth information.

205: Determine target point cloud data at the second resolution based on the spatial position information of the target feature point and the original point cloud data.

The target point cloud data is upsampled original point cloud data. The target point cloud data may include the original point cloud data and interpolated point cloud data. The interpolated point cloud data may include the spatial position information corresponding to the target feature point.

In some embodiments, the original point cloud data may include only the spatial position information of the feature points. In some other embodiments, the original point cloud data may include information about at least four dimensions, for example, may include three-dimensional spatial position information and attribute information. The attribute information is information representing a target surface feature. For example, the attribute information herein may include reflection intensity information, color information, and the like.

The reflection intensity information is specifically a laser beam point intensity value corresponding to a corresponding feature point. The laser beam point intensity value is related to a material of an object to which a laser is emitted and a distance between the laser and the object. For example, an intensity value obtained when the laser is emitted to a tree is generally different from an intensity value obtained when the laser is emitted to glass.

Specifically, different collection principles for collecting point cloud data correspond to different attribute information. For example, if a collection device for collecting the point cloud data is a collection device based on a laser measurement principle, the attribute information may be reflection intensity information. The reflection intensity information is reflection intensity of a corresponding laser radar pulse echo when the collection device collects data of a specific point. Different objects have different reflection for reflecting a laser, and different objects can be distinguished based on reflection intensity information. If the collection device for collecting point cloud data is a collection device based on a photogrammetric principle, the attribute information may be color information.

In this embodiment, the original point cloud data further includes attribute information corresponding to the feature points, the image channel of the depth image includes a depth channel and an attribute channel, pixel values of the mapped pixel points in the depth channel represent the depth information of the feature points corresponding to the mapped pixel points, and pixel values of the mapped pixel points in the attribute channel represents attribute information of the feature points corresponding to the mapped pixel points.

Before the operation of “determining target point cloud data at the second resolution based on the spatial position information of the target feature point and the original point cloud data”, the method may further include the following operation:
performing pixel point interpolation under the attribute channel on the depth image based on the attribute information corresponding to the mapped pixel points in the attribute channel, to obtain a pixel value of the interpolated pixel point under the attribute channel, the pixel value of the interpolated pixel point under the attribute channel representing attribute information of the target feature point that corresponds to the interpolated pixel point and that is in the three-dimensional scene.

The operation of “determining target point cloud data at the second resolution based on the spatial position information of the target feature point and the original point cloud data” may include the following operation:
determining the target point cloud data at the second resolution based on the spatial position information and the attribute information of the target feature point, and the original point cloud data.

If the original point cloud data further includes the attribute information of the feature points, in this embodiment, interpolation may alternatively be performed on the attribute information of the point cloud data. For a process of performing interpolation on the attribute information, refer to the process of performing interpolation on the depth information in the foregoing embodiment. Details are not described herein again.

The spatial position information and the attribute information of the target feature point that corresponds to the interpolated pixel point and that is in the three-dimensional scene may be obtained through depth information interpolation and attribute information interpolation.

In this embodiment, the operation of “performing pixel point interpolation under the attribute channel on the depth image based on the attribute information corresponding to the mapped pixel points in the attribute channel, to obtain a pixel value of the interpolated pixel point under the attribute channel” may include the following operations:
determining a pixel position of a to-be-interpolated pixel point in the depth image, and determining adjacent pixel points of the to-be-interpolated pixel point from the mapped pixel points based on the mapped pixel points and the pixel position of the to-be-interpolated pixel point in the depth image; and
fusing attribute information corresponding to the adjacent pixel points, to determine attribute information of the to-be-interpolated pixel point.

In this embodiment, the operation of “fusing attribute information corresponding to the adjacent pixel points, to determine attribute information of the to-be-interpolated pixel point” may include the following operations:
determining pixel distances between the adjacent pixel points and the to-be-interpolated pixel point based on pixel positions of the adjacent pixel points and the pixel position of the to-be-interpolated pixel point in the depth image;
determining weight information of the adjacent pixel points based on the pixel distances; and
fusing, based on the weight information, the attribute information corresponding to the adjacent pixel points, to determine the attribute information of the to-be-interpolated pixel point.

In this embodiment, before the operation of “fusing, based on the weight information, the attribute information corresponding to the adjacent pixel points, to determine the attribute information of the to-be-interpolated pixel point”, the method may further include the following operations:
detecting the attribute information corresponding to the mapped pixel points in the depth image; and
determining the mapped pixel points as abnormal pixel points when it is detected that the attribute information corresponding to the mapped pixel points does not satisfy a preset attribute condition.

The operation of “fusing, based on the weight information, the attribute information corresponding to the adjacent pixel points, to determine the attribute information of the to-be-interpolated pixel point” may include the following operations:
detecting whether the adjacent pixel points are abnormal pixel points, to obtain a detection result; and
fusing, based on the detection result and the weight information, the attribute information corresponding to the adjacent pixel points, to determine the attribute information of the to-be-interpolated pixel point.

In this embodiment, the operation of “fusing, based on the detection result and the weight information, the attribute information corresponding to the adjacent pixel points, to determine the attribute information of the to-be-interpolated pixel point” may include the following operations:
setting weight adjustment coefficients of the adjacent pixel points based on the detection result;
updating the weight information of the adjacent pixel points based on the weight adjustment coefficients; and
fusing, based on updated weight information, the attribute information corresponding to the adjacent pixel points, to determine the attribute information of the to-be-interpolated pixel point.

In this embodiment, the operation of “determining weight information of the adjacent pixel points based on the pixel distances” may include the following operations:
determining first weight information of the adjacent pixel points based on the pixel distances;
comparing the attribute information corresponding to the adjacent pixel points and reference attribute information, to determine relative attribute information corresponding to the adjacent pixel points;
determining second weight information of the adjacent pixel points based on the relative attribute information; and
fusing the first weight information and the second weight information, to obtain the weight information of the adjacent pixel points.

In this embodiment, the operation of “comparing the attribute information corresponding to the adjacent pixel points and reference attribute information, to determine relative attribute information corresponding to the adjacent pixel points” may include the following operations:
selecting, based on a magnitude of the attribute information corresponding to the adjacent pixel points, the reference attribute information from the attribute information corresponding to the adjacent pixel points; and
comparing the attribute information corresponding to the adjacent pixel points and the reference attribute information, to determine the relative attribute information corresponding to the adjacent pixel points.

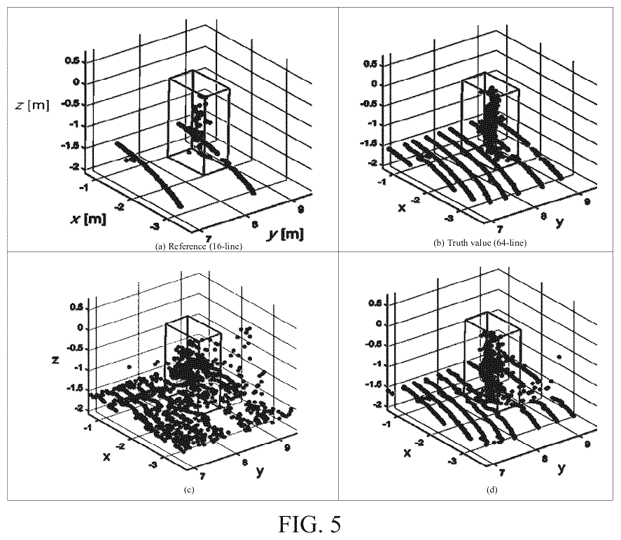

In a specific embodiment, a modeling effect of the point cloud data obtained based on the interpolation method provided in this application may be compared with a modeling effect of a truth value. (a) in FIG. 5 shows original point cloud data of a 16-line laser radar. (b) in FIG. 5 shows a ground truth of a 64-line laser radar. (c) and (d) in FIG. 5 both show the method provided in this application.

Specifically, upsampling is performed on the range image by using the pixel distance weighted interpolation method in the foregoing embodiment, to obtain an interpolated extended range image. In this embodiment, an interpolation output in the two-dimensional extended range image may be converted into a three-dimensional point cloud, for a visual analysis on an interpolation effect, as shown in (c) in FIG. 5. A distance weighted interpolation result represents a denser 3D output, which can fully describe a shape of an object, but noise data is enlarged.

A size of the two-dimensional range image is increased by using the pixel distance and range weighted interpolation method, and the three-dimensional point cloud is constructed by using the interpolated extended range image, so that the noise data can be well removed, to further improve interpolation performance. As shown in (d) in FIG. 5, for the interpolation result, noise interpolation data is clearly removed, upsampling enhancement is performed on the point cloud data, and a shape of a high-resolution LiDAR point can be fully represented. It can be learned through comparison with (b) in FIG. 5 that a result obtained by using the pixel distance and range weighted interpolation method is approximate to a 64-Ch (64-line) truth value, and a simulation model obtained through interpolation is well consistent with a shape obtained through sampling by using the 64-line laser radar. According to the pixel distance and range weighted interpolation method, an adjacent pixel point that is an outlier point can be removed, to reduce negative impact of an abnormal pixel point (that is, the outlier point) during interpolation. In comparison with surrounding data, an adjacent point of which a depth value corresponding to depth information is zero or is far greater than a preset threshold may be considered as an outlier point. Specifically, zero or a maximum pixel in the two-dimensional range image is a LiDAR beam point that is not projected on an object within a measurable range.

In this application, a range image and point cloud data can be combined, and a brand new method for upsampling point cloud data is provided, to effectively improve precision and robustness of three-dimensional object detection. The point cloud data processing method provided in this application includes pixel distance weighted interpolation and pixel distance and range weighted interpolation. In the pixel distance weighted interpolation method, distances between pixels are considered, and a close pixel is endowed with a higher weight, so that a contour and an edge of an object are described more accurately. In the pixel distance and range weighted interpolation method, a distance and a range between pixels are further considered, so that a complex structure and shape of an object can be well dealt with.

In this embodiment, the provided laser radar upsampling method may be used as an input of a selected three-dimensional target detection model, and detection precision is evaluated, to verify effectiveness of the method. A PointPillar model is used as a three-dimensional model, and is an effective and widely applied three-dimensional target detection network model of laser radar data. The model uses the method to upsample a data set from baseline point cloud data for training.

A baseline point cloud data set includes point cloud data of a low-resolution (32-line) laser radar, and the data set is generated by downsampling a KITTI three-dimensional data set of a 64-line laser radar. Specifically, point cloud data of the 64-line LiDAR may be converted into a range image, to obtain a high-resolution LiDAR range image. Some rows are extracted from a range image of the 64-line laser radar, to obtain a low-resolution range image. For example, a range image corresponding to a 32-line laser radar may be extracted, and then the range image is converted into point cloud data corresponding to the 32-line laser radar, so that upsampling is performed on the point cloud data corresponding to the 32-line laser radar by using the methods, and then an obtained processing result is inputted into the three-dimensional target detection model (that is, the PointPillar model), to evaluate effectiveness of target detection.

Quantities of data files in a training data set, a verification data set, and a test data set of the PointPillar model are respectively 7481, 1856, and 3769. According to most common obstacles in a self-driving environment, that is, an automobile, a pedestrian, and a rider, classification is performed based on mean average precision (mAP) in difficulty levels of easy, medium, and hard, to evaluate overall performance of a 3D detection task.

Specifically, the 32-line LiDAR may be reconstructed into the 64-line LiDAR by using the upsampling method provided in this application and a current widely used upsampling method separately, and reconstruction effects are compared. The same baseline data set is configured for upsampling, and the PointPillar model is configured for detection.

Table 1 is a table of target detection performance comparison of a pre-trained PointPillar model (upsampled from 32-line to 64-Ch). Table 1 provides detected mAP values of categories of pedestrian, rider, and automobile, and detection enhancement effects brought by different upsampling methods are analyzed through comparison. Intersection over union (IoU) of 0.7 is used for evaluation. E, M, and H respectively represent difficulty levels of easy, medium, and hard.

TABLE 1

| | | Pedestrian | Rider | Automobile | Overall |
|---|---|---|---|---|---|
| Reference | E | 30.01 | 58.13 | 65.82 | 51.32 |
| (32-line) | M | 25.98 | 36.88 | 51.88 | 38.25 |
| | H | 23.95 | 35.58 | 46.25 | 35.26 |
| Nearest-neighbor | E | 27.39 | 49.09 | 40.60 | 39.03 |
| interpolation | M | 24.22 | 30.95 | 30.13 | 28.43 |
| | H | 22.00 | 29.75 | 26.99 | 26.25 |
| Bilinear | E | 20.67 | 38.31 | 30.97 | 29.98 |
| interpolation | M | 18.13 | 24.51 | 21.12 | 21.25 |
| | H | 16.99 | 22.95 | 17.72 | 19.22 |
| Efficient sub-pixel | E | 2.45 | 2.90 | 6.67 | 4.01 |
| convolutional neural | M | 2.57 | 2.55 | 5.77 | 3.63 |
| network (ESPCN) | H | 2.61 | 2.56 | 4.55 | 3.24 |
| upsampling method | | | | | |
| Shan upsampling | E | 9.29 | 5.72 | 5.20 | 6.74 |
| method | M | 9.09 | 9.34 | 4.55 | 7.66 |
| | H | 9.09 | 9.29 | 4.55 | 7.64 |
| Method provided | E | 39.96 | 64.95 | 75.06 | 59.99 |
| in this | M | 35.18 | 43.19 | 57.72 | 45.36 |
| application | H | 37.71 | 39.95 | 54.19 | 41.95 |

The IoU is a ratio of an intersection set to a union set, is usually configured for measuring an overlapping degree of two sets, and is especially configured for evaluating accuracy of a model prediction result in target detection and image segmentation.

It can be learned from Table 1 that 3D detection performance of existing methods such as the nearest-neighbor interpolation, the bilinear interpolation, the ESPCN upsampling method based on a convolutional neural network (CNN), and the Shan upsampling is poor. The 3D detection performance reflects upsampling performance of a corresponding method from a low-resolution (16-line) laser radar point cloud to a high-resolution (64-line) point cloud. A denser point cloud with a low overall loss fraction can be reconstructed by using these methods. However, an object shape cannot be accurately reconstructed, resulting in poor detection performance.

Specifically, a complex shape, for example, a curve, of an object cannot be described by using the nearest-neighbor interpolation method. During the bilinear interpolation, some noise points are generated around a target. When upsampling is performed by using a deep learning-based model, point distribution cannot be used for fully describing a shape of an object, and there is a large amount of noise around a target.

The ESPCN upsampling method is an upsampling method for extracting a plurality of features from an aggregated low-resolution feature map to reconstruct a high-resolution image output. The Shan upsampling method is a method for upsampling by using an encoder-decoder architecture in a residual connection. Both the ESPCN upsampling method and the Shan upsampling are upsampling based on deep learning. A large amount of training data is needed to help a deep learning model to perform image reconstruction, and calculation complexity is high, which is difficult for parameter selection.

In comparison with the upsampling method based on deep learning, the method in this application has significant advantages. A shape of an object can be well described, and generation of noise is greatly reduced. In addition, the pixel distance weighted interpolation method and the pixel distance and range weighted interpolation method used in this application are not based on deep learning, and excessive parameters are not needed, so that the methods have significant advantages in terms of calculation efficiency. Further, in the methods in this application, a large amount of training data is not needed, and the methods have better universality and practicability.

In addition, Table 1 further provides a comparison between detections on medium-level categories. It can be clearly learned that, in comparison with an existing upsampling method, a proposed solution (Case C) exhibits best performance in each category of detection, and performance of a three-dimensional target detection task is improved. The mAP of the category overall (level M) is 45.4%, and is approximately 7% higher than that of the baseline data set.

In conclusion, this application provides a low-resolution laser radar upsampling method. In the method, low-resolution point cloud data with coarse details can be converted into corresponding high-resolution point cloud data with fine details, so that a three-dimensional target detection capability is enhanced.

This application provides an effective low-resolution laser radar point cloud upsampling method. A target in sparse point cloud data is reconstructed into data with higher vertical angle resolution, so that accuracy of three-dimensional target detection is improved. The method may be applied to a plurality of scenarios of self-driving, including but not limited to three-dimensional object detection, road surface detection, terrain modeling, environment sensing, and the like.

For example, a self-driving automobile needs to detect objects such as an obstacle, a pedestrian, or a vehicle in a surrounding environment in real time, to ensure driving safety. The three-dimensional point cloud upsampling method provided in this application is used, so that density and a resolution of a point cloud can be improved, to improve precision and robustness of object detection.

For another example, a self-driving automobile needs to detect a road condition in real time, including information such as flatness, levelness, and potholes, to ensure driving stability and safety. The three-dimensional point cloud upsampling method provided in this application is used, so that density and a resolution of a point cloud can be improved, to improve precision and robustness of road detection.

For another example, a self-driving automobile needs to construct a three-dimensional terrain model of a surrounding environment in real time, to perform path planning and navigation. The three-dimensional point cloud upsampling method provided in this application is used, so that density and a resolution of a point cloud can be improved, to improve precision and robustness of terrain modeling.

For still another example, a self-driving automobile needs to sense status and changes of a surrounding environment in real time, including information such as weather, illumination, a road condition, and a traffic condition, to perform intelligent decision and control. The three-dimensional point cloud upsampling method provided in this application is used, so that density and a resolution of a point cloud can be improved, to improve precision and robustness of environment sensing.

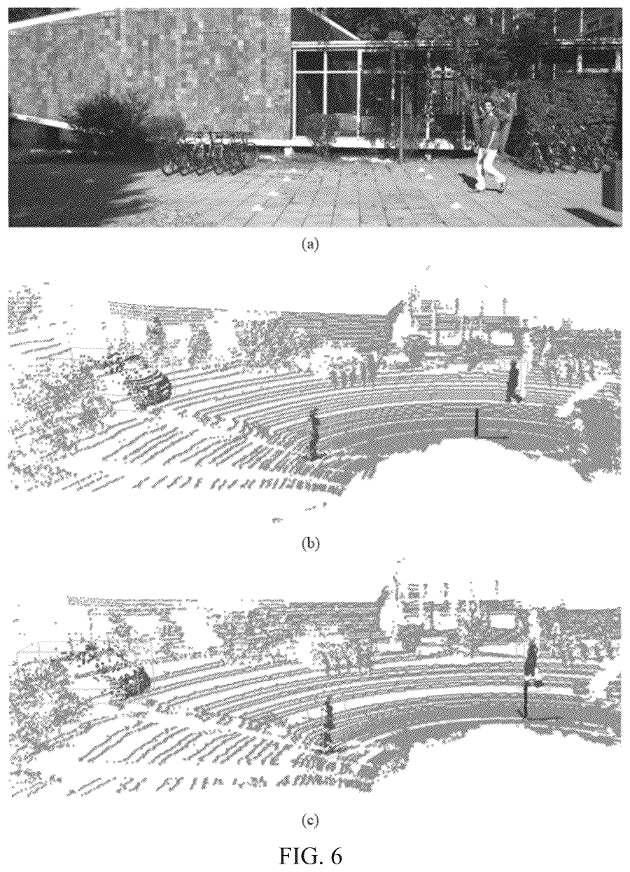

In a specific scenario, FIG. 6 shows an example of three-dimensional target detection. (a) in FIG. 6 shows a red, green, and blue (RGB) image of a three-dimensional scene. (b) in FIG. 6 shows a three-dimensional detection result using a 64-line truth value. (c) in FIG. 6 shows a three-dimensional detection result obtained through upsampling by using the point cloud data processing method provided in this application. It can be learned from comparison that, a shape of an object can be well described by using the point cloud data processing method provided in this application, to improve accuracy of pedestrian detection.

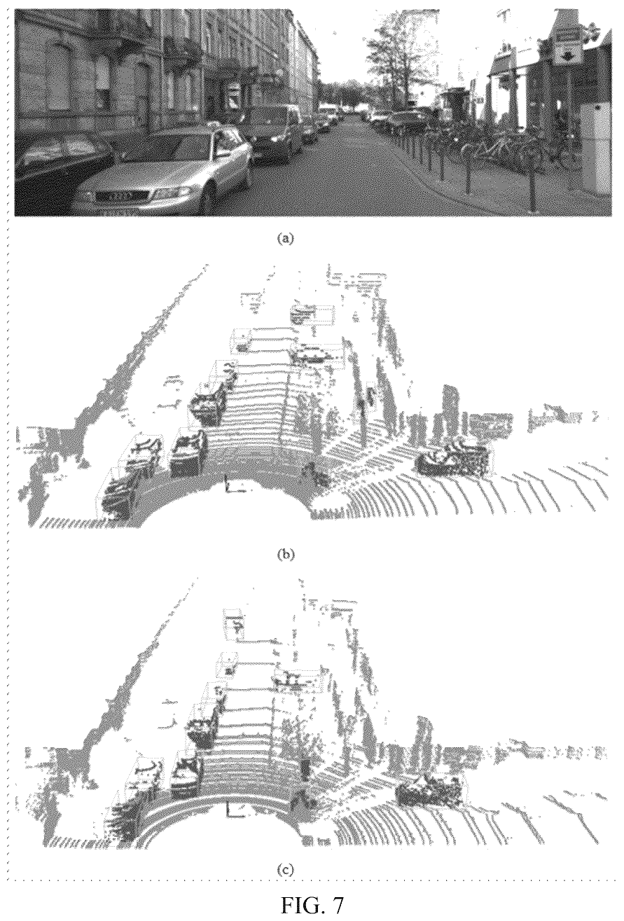

In a specific scenario, FIG. 7 shows another example of three-dimensional target detection. (a) in FIG. 7 shows an RGB image of a three-dimensional scene. (b) in FIG. 7 shows a three-dimensional detection result using a 64-line truth value. (c) in FIG. 7 shows a three-dimensional detection result obtained through upsampling by using the point cloud data processing method provided in this application. It can be learned from comparison that, a shape of an object can be well described by using the point cloud data processing method provided in this application, to improve accuracy of vehicle detection.

The upsampling method provided in this application can further be combined with a three-dimensional target detection model based on a 2D range image, for example, a range-sparse network (RSN), to construct an end-to-end network.

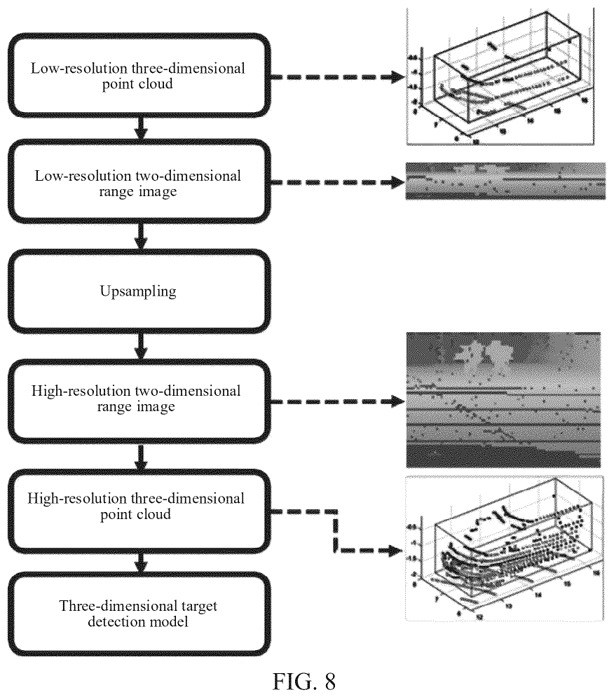

This application provides a simple and effective low-resolution laser radar sparse point cloud upsampling method. Unordered three-dimensional point cloud data is projected on an ordered multi-channel range image, and then the range image is reconstructed as a dense three-dimensional point cloud. Specifically, as shown in FIG. 8, low-resolution three-dimensional point cloud data may be first converted into a low-resolution two-dimensional range image, and then upsampling is performed on the two-dimensional range image, to obtain a high-resolution two-dimensional range image. Then, the high-resolution two-dimensional range image is converted into high-resolution three-dimensional point cloud data, so that target detection is performed on the high-resolution three-dimensional point cloud data by using a three-dimensional target detection model. In this way, accuracy of target detection can be improved, and a three-dimensional target detection capability of a low-resolution laser radar can be enhanced.

It may be learned from the foregoing that, in this embodiment, original point cloud data at a first resolution may be obtained, where the original point cloud data includes a plurality of feature points obtained by sampling a three-dimensional scene and spatial position information of the feature points, and the spatial position information of the feature points represents spatial positions corresponding to the feature points in the three-dimensional scene; the feature points are respectively mapped to mapped pixel points in a depth image at the first resolution based on the spatial position information of the feature points in the original point cloud data, where pixel values of the mapped pixel points represent depth information of the mapped feature points; interpolation is performed on the depth image based on the depth information represented by the pixel values of the mapped pixel points in the depth image, to obtain an extended depth image at a second resolution; spatial position transformation is performed on an interpolated pixel point based on a pixel position of the interpolated pixel point in the extended depth image, to obtain spatial position information of a target feature point that corresponds to the interpolated pixel point and that is in the three-dimensional scene; and target point cloud data at the second resolution is determined based on the spatial position information of the target feature point and the original point cloud data.

In this application, point cloud data may be first converted into a corresponding depth image, interpolation is performed based on the depth image, and finally, a processed extended depth image is converted into high-resolution point cloud data. In this way, a resolution of point cloud data can be effectively improved, and obtained point distribution can fully describe a shape of an object, to improve accuracy of object detection. In addition, a large amount of training data is not needed, calculation complexity is low, and commonality and practicability are good.

According to the method described in the foregoing embodiment, the following further provides detailed descriptions by using an example in which the point cloud data processing apparatus is specifically integrated in a server.

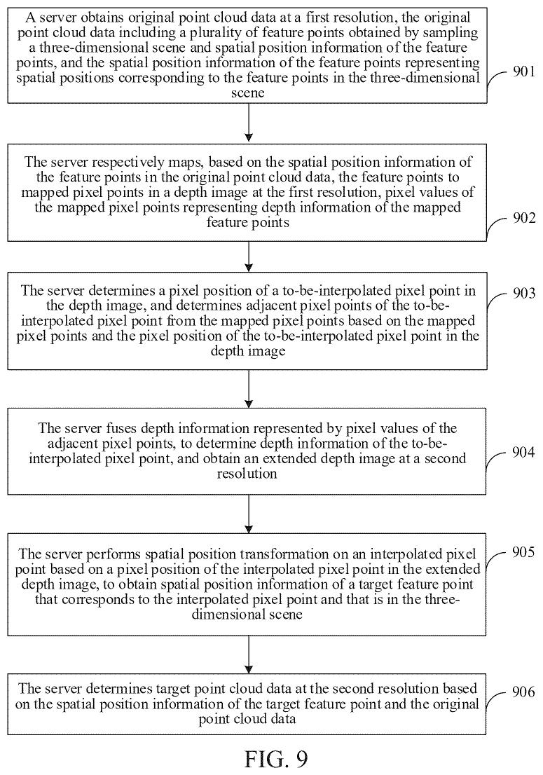

An embodiment of this application provides a point cloud data processing method. As shown in FIG. 9, the point cloud data processing method may be as follows.

901: A server obtains original point cloud data at a first resolution, the original point cloud data including a plurality of feature points obtained by sampling a three-dimensional scene and spatial position information of the feature points, and the spatial position information of the feature points representing spatial positions corresponding to the feature points in the three-dimensional scene.

The original point cloud data is a point data set in a specific coordinate system obtained by scanning the three-dimensional scene by using a measurement instrument. The measurement instrument may be a laser radar. The original point cloud data includes a plurality of sampling points, and each sampling point is a feature point.

Specifically, the feature point is obtained through sampling of a plurality of groups of lasers simultaneously emitted by a rotating laser radar to the three-dimensional scene along different vertical angles based on a horizontal azimuth angle resolution. Different groups of lasers correspond to different vertical channels, in other words, correspond to different vertical angles.

902: The server respectively maps, based on the spatial position information of the feature points in the original point cloud data, the feature points to mapped pixel points in a depth image at the first resolution, pixel values of the mapped pixel points representing depth information of the mapped feature points.

The depth information of the feature point may be a distance between the feature point and the measurement instrument, and the distance between the feature point and the measurement instrument is specifically a distance between the feature point and the laser radar. The depth information of the feature point may be determined based on the spatial position information of the feature point.

The preset image may be a blank image, and pixel values of pixel points in the blank image are zero. A row of the preset image may represent a horizontal azimuth angle (that is, a horizontal angle), and a column represents a vertical angle.

For the feature points in the original point cloud data, position transformation may be performed on the spatial position information of the feature points, to convert the three-dimensional coordinates into two-dimensional coordinates, so as to map the feature points to the preset image. Through the position transformation, the unordered three-dimensional point cloud data may be projected on the ordered depth image. The feature points in the original point cloud data are in one-to-one correspondence with the mapped pixel points in the depth image.

The depth image is an image in which point cloud data in three-dimensional space is mapped to a two-dimensional plane, and may also be referred to as a range image. A pixel value of a pixel point in the image represents depth information of a corresponding point. The pixel point in the depth image may have one or more image channels (Ch). One image channel may correspond to one type of information, and a quantity of image channels is related to a quantity of types of information. In a specific embodiment, the pixel point in the depth image may have a depth channel and an attribute channel. The depth channel is a distance measurement channel, and the attribute channel may include an intensity channel, a color channel, or the like. A depth value corresponding to the pixel point in the distance measurement channel indicates a distance between a corresponding feature point and the laser radar. A depth value corresponding to the pixel point in the intensity channel indicates an intensity value of a laser beam point corresponding to the corresponding feature point. A pixel value corresponding to the pixel point in the color channel indicates color information corresponding to the corresponding feature point.

903: The server determines a pixel position of a to-be-interpolated pixel point in the depth image, and determines adjacent pixel points of the to-be-interpolated pixel point from the mapped pixel points based on the mapped pixel points and the pixel position of the to-be-interpolated pixel point in the depth image.

In some embodiments, a mapped pixel point of which a pixel distance to the to-be-interpolated pixel point is less than a preset distance may be determined as an adjacent pixel point of the to-be-interpolated pixel point. The pixel distance is a distance between two pixel points in the depth image. In some other embodiments, adjacent pixel points of a specific to-be-interpolated pixel point may be k mapped pixel points that are closest to the to-be-interpolated pixel point in terms of a pixel distance and that have depth information. k may be set based on an actual situation, for example, may be set to 6.

904: The server fuses depth information represented by pixel values of the adjacent pixel points, to determine depth information of the to-be-interpolated pixel point, to obtain an extended depth image at a second resolution.

The second resolution is greater than the first resolution. The second resolution may include a horizontal azimuth angle resolution and a vertical angle resolution. Specifically, in this embodiment, upsampling (that is, interpolation) may be performed in a horizontal direction and an elevation direction, or upsampling may be performed in only one of the horizontal direction and the elevation direction. For example, upsampling may be performed only in the elevation direction, to increase density of a vertical angle of a laser radar channel. In this way, in comparison with the first resolution, for the second resolution, only the vertical angle resolution changes, and the horizontal azimuth angle resolution remains unchanged. For another example, upsampling may be performed only in the horizontal direction. In this way, in comparison with the first resolution, for the second resolution, only the horizontal azimuth angle resolution changes, and the vertical angle resolution remains unchanged.

The extended depth image is an interpolated depth image.

In this embodiment, the operation of “fusing depth information represented by pixel values of the adjacent pixel points, to determine depth information of the to-be-interpolated pixel point” may include the following operations:
determining pixel distances between the adjacent pixel points and the to-be-interpolated pixel point based on pixel positions of the adjacent pixel points and the pixel position of the to-be-interpolated pixel point in the depth image;
determining weight information of the adjacent pixel points based on the pixel distances; and
fusing, based on the weight information, the depth information represented by
the pixel values of the adjacent pixel points, to determine the depth information of the to-be-interpolated pixel point.

A longer pixel distance indicates smaller weight information of the adjacent pixel points. Otherwise, a shorter pixel distance indicates greater weight information of the adjacent pixel points.

In this embodiment, before the operation of “fusing, based on the weight information, the depth information represented by the pixel values of the adjacent pixel points, to determine the depth information of the to-be-interpolated pixel point”, the point cloud data processing method may further include the following operation:
determining the mapped pixel points as abnormal pixel points when depth information corresponding to the mapped pixel points does not satisfy a preset depth condition.

The operation of “fusing, based on the weight information, the depth information represented by the pixel values of the adjacent pixel points, to determine the depth information of the to-be-interpolated pixel point” may include the following operations:
detecting whether the adjacent pixel points are abnormal pixel points, to obtain a detection result; and
fusing, based on the detection result and the weight information, the depth information represented by the pixel values of the adjacent pixel points, to determine depth information of the to-be-interpolated pixel point.

The preset depth condition may be set based on an actual situation. For example, the preset depth condition may be set as that when a depth value corresponding to depth information of a pixel point is within a preset range, the pixel point is a non-abnormal pixel point. An excessively large or excessively small depth value usually indicates an outlier point. In this embodiment, anomaly detection may be performed on the adjacent pixel points, to reduce negative impact of an abnormal pixel point (that is, the outlier point) during interpolation.

In this embodiment, the operation of “fusing, based on the detection result and the weight information, the depth information represented by the pixel values of the adjacent pixel points, to determine depth information of the to-be-interpolated pixel point” may include the following operations:
setting weight adjustment coefficients of the adjacent pixel points based on the detection result;
updating the weight information of the adjacent pixel points based on the weight adjustment coefficients; and
fusing, based on updated weight information, the depth information represented by the pixel values of the adjacent pixel points, to determine the depth information of the to-be-interpolated pixel point.

When it is detected that an adjacent pixel point is an abnormal pixel point, a weight adjustment coefficient of the adjacent pixel point may be set to 0, to reduce impact of the abnormal pixel point. When it is detected that the adjacent pixel point is not an abnormal pixel point, the weight adjustment coefficient of the adjacent pixel point may be set to 1.

In some embodiments, weight adjustment coefficients and the weight information of the adjacent pixel points may be fused to update the weight information of the adjacent pixel points. A fusion manner may be multiplication or the like.

In this embodiment, the operation of “determining weight information of the adjacent pixel points based on the pixel distances” may include the following operations:
determining first weight information of the adjacent pixel points based on the pixel distances;
comparing the depth information represented by the pixel values of the adjacent pixel points and reference depth information, to determine relative depth information corresponding to the adjacent pixel points;
determining second weight information of the adjacent pixel points based on the relative depth information; and
fusing the first weight information and the second weight information, to obtain the weight information of the adjacent pixel points.

The first weight information and the second weight information are fused in a plurality of manners, which is not limited in this embodiment. For example, a fusion manner may be multiplication or the like.

The reference depth information may be set based on an actual situation.

In this embodiment, the operation of “comparing the depth information represented by the pixel values of the adjacent pixel points and reference depth information, to determine the relative depth information corresponding to the adjacent pixel points” may include the following operations:
selecting, based on a magnitude of the depth information represented by the pixel values of the adjacent pixel points, the reference depth information from the depth information represented by the pixel values of the adjacent pixel points; and
comparing the depth information represented by the pixel values of the adjacent pixel points and the reference depth information, to determine the relative depth information corresponding to the adjacent pixel points.

In some embodiments, depth information with a minimum depth value may be selected from the depth information of the adjacent pixel points of the to-be-interpolated pixel point as the reference depth information.

Comparing the depth information represented by the pixel values of the adjacent pixel points and the reference depth information may be specifically that a difference operation is performed on the depth information represented by the pixel values of the adjacent pixel points and the reference depth information, and obtained differences are the relative depth information corresponding to the adjacent pixel points.

905: The server performs spatial position transformation on an interpolated pixel point based on a pixel position of the interpolated pixel point in the extended depth image, to obtain spatial position information of a target feature point that corresponds to the interpolated pixel point and that is in the three-dimensional scene.

In this embodiment, the operation of “performing spatial position transformation on an interpolated pixel point based on a pixel position of the interpolated pixel point in the extended depth image, to obtain spatial position information of a target feature point that corresponds to the interpolated pixel point and that is in the three-dimensional scene” may include the following operations:
determining, based on the pixel position of the interpolated pixel point in the extended depth image, a horizontal azimuth angle and a vertical angle that correspond to the interpolated pixel point; and
performing spatial position transformation on the interpolated pixel point based on the depth information, the horizontal azimuth angle, and the vertical angle of the interpolated pixel point, to obtain the spatial position information of the target feature point that corresponds to the interpolated pixel point and that is in the three-dimensional scene.

The depth information of the interpolated pixel point may specifically represent a distance value between a corresponding feature point and a target measurement instrument (specifically, the laser radar).

906: The server determines target point cloud data at the second resolution based on the spatial position information of the target feature point and the original point cloud data.

This application provides an effective low-resolution laser radar point cloud upsampling method. A target in sparse point cloud data is reconstructed into data with higher vertical angle resolution, so that accuracy of three-dimensional target detection is improved. The method may be applied to a plurality of scenarios of self-driving, including but not limited to three-dimensional object detection, road surface detection, terrain modeling, environment sensing, and the like.

It may be learned from the foregoing that, in this embodiment, the server may obtain original point cloud data at a first resolution, where the original point cloud data includes a plurality of feature points obtained by sampling a three-dimensional scene and spatial position information of the feature points, and the spatial position information of the feature points represents spatial positions corresponding to the feature points in the three-dimensional scene; respectively map, based on the spatial position information of the feature points in the original point cloud data, the feature points to mapped pixel points in a depth image at the first resolution, where pixel values of the mapped pixel points represent depth information of the mapped feature points; determine a pixel position of a to-be-interpolated pixel point in the depth image, and determining adjacent pixel points of the to-be-interpolated pixel point from the mapped pixel points based on the mapped pixel points and the pixel position of the to-be-interpolated pixel point in the depth image; fuse depth information represented by pixel values of the adjacent pixel points, to determine depth information of the to-be-interpolated pixel point, to obtain an extended depth image at a second resolution; perform spatial position transformation on an interpolated pixel point based on a pixel position of the interpolated pixel point in the extended depth image, to obtain spatial position information of a target feature point that corresponds to the interpolated pixel point and that is in the three-dimensional scene; and determining target point cloud data at the second resolution based on the spatial position information of the target feature point and the original point cloud data.

In this application, point cloud data may be first converted into a corresponding depth image, interpolation is performed based on the depth image, and finally, a processed extended depth image is converted into high-resolution point cloud data. In this way, a resolution of point cloud data can be effectively improved, and obtained point distribution can fully describe a shape of an object, to improve accuracy of object detection. In addition, a large amount of training data is not needed, calculation complexity is low, and commonality and practicability are good.

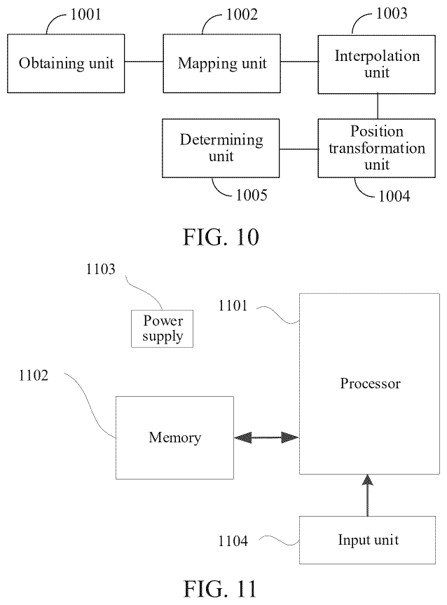

To better implement the foregoing method, an embodiment of this application further provides a point cloud data processing apparatus. As shown in FIG. 10, the point cloud data processing apparatus may include an obtaining unit 1001, a mapping unit 1002, an interpolation unit 1003, a position transformation unit 1004, and a determining unit 1005 as follows.

### (1) The Obtaining Unit 1001:

The obtaining unit is configured to obtain original point cloud data at a first resolution, the original point cloud data including a plurality of feature points obtained by sampling a three-dimensional scene and spatial position information of the feature points, and the spatial position information of the feature points representing spatial positions corresponding to the feature points in the three-dimensional scene.

### (2) the Mapping Unit 1002:

The mapping unit is configured to respectively map, based on the spatial position information of the feature points in the original point cloud data, the feature points to mapped pixel points in a depth image at the first resolution, pixel values of the mapped pixel points representing depth information of the mapped feature points.

### (3) the Interpolation Unit 1003:

The interpolation unit is configured to perform interpolation on the depth image based on the depth information represented by the pixel values of the mapped pixel points in the depth image, to obtain an extended depth image at a second resolution.

In some embodiments of this application, the interpolation unit may include a determining subunit and a fusion subunit as follows.

The determining subunit is configured to determine a pixel position of a to-be-interpolated pixel point in the depth image, and determining adjacent pixel points of the to-be-interpolated pixel point from the mapped pixel points based on the mapped pixel points and the pixel position of the to-be-interpolated pixel point in the depth image.

The fusion subunit is configured to fuse depth information represented by pixel values of the adjacent pixel points, to determine depth information of the to-be-interpolated pixel point, and obtain the extended depth image at the second resolution.

In some embodiments of this application, the fusion subunit may be specifically configured to determine pixel distances between the adjacent pixel points and the to-be-interpolated pixel point based on pixel positions of the adjacent pixel points and the pixel position of the to-be-interpolated pixel point in the depth image; determine weight information of the adjacent pixel points based on the pixel distances; and fuse, based on the weight information, the depth information represented by the pixel values of the adjacent pixel points, to determine the depth information of the to-be-interpolated pixel point.

In some embodiments of this application, before the operation of “fusing, based on the weight information, the depth information represented by the pixel values of the adjacent pixel points, to determine the depth information of the to-be-interpolated pixel point”, the point cloud data processing method may include the following operation:
determining the mapped pixel points as abnormal pixel points when depth information corresponding to the mapped pixel points does not satisfy a preset depth condition.

The operation of “fusing, based on the weight information, the depth information represented by the pixel values of the adjacent pixel points, to determine the depth information of the to-be-interpolated pixel point” may include the following operations:
detecting whether the adjacent pixel points are abnormal pixel points, to obtain a detection result; and
fusing, based on the detection result and the weight information, the depth information represented by the pixel values of the adjacent pixel points, to determine depth information of the to-be-interpolated pixel point.

In some embodiments of this application, the operation of “fusing, based on the detection result and the weight information, the depth information represented by the pixel values of the adjacent pixel points, to determine depth information of the to-be-interpolated pixel point” may include the following operations:
setting weight adjustment coefficients of the adjacent pixel points based on the detection result;
updating the weight information of the adjacent pixel points based on the weight adjustment coefficients; and
fusing, based on updated weight information, the depth information represented by the pixel values of the adjacent pixel points, to determine the depth information of the to-be-interpolated pixel point.

In some embodiments of this application, the operation of “determining weight information of the adjacent pixel points based on the pixel distances” may include the following operations:
determining first weight information of the adjacent pixel points based on the pixel distances;
comparing the depth information represented by the pixel values of the adjacent pixel points and reference depth information, to determine relative depth information corresponding to the adjacent pixel points;
determining second weight information of the adjacent pixel points based on the relative depth information; and
fusing the first weight information and the second weight information, to obtain the weight information of the adjacent pixel points.

In some embodiments of this application, the operation of “comparing the depth information represented by the pixel values of the adjacent pixel points and the reference depth information, to determine the relative depth information corresponding to the adjacent pixel points” may include the following operations:
selecting, based on a magnitude of the depth information represented by the pixel values of the adjacent pixel points, the reference depth information from the depth information represented by the pixel values of the adjacent pixel points; and
comparing the depth information represented by the pixel values of the adjacent pixel points and the reference depth information, to determine the relative depth information corresponding to the adjacent pixel points.

### (4) the Position Transformation Unit 1004:

The position transformation unit is configured to perform spatial position transformation on an interpolated pixel point based on a pixel position of the interpolated pixel point in the extended depth image, to obtain spatial position information of a target feature point that corresponds to the interpolated pixel point and that is in the three-dimensional scene.

In some embodiments of this application, the position transformation unit may include an angle determining subunit and a transformation subunit as follows.

The angle determining subunit is configured to determine, based on the pixel position of the interpolated pixel point in the extended depth image, a horizontal azimuth angle and a vertical angle that correspond to the interpolated pixel point.

The transformation subunit is configured to perform spatial position transformation on the interpolated pixel point based on the depth information, the horizontal azimuth angle, and the vertical angle corresponding to the interpolated pixel point, to obtain the spatial position information of the target feature point that corresponds to the interpolated pixel point and that is in the three-dimensional scene.

### (5) the Determining Unit 1005:

The determining unit is configured to determine target point cloud data at the second resolution based on the spatial position information of the target feature point and the original point cloud data.

In some embodiments of this application, the original point cloud data further includes attribute information corresponding to the feature points, an image channel of the depth image includes a depth channel and an attribute channel, pixel values of the mapped pixel points in the depth channel represent the depth information of the feature points corresponding to the mapped pixel points, and pixel values of the mapped pixel points in the attribute channel represents attribute information of the feature points corresponding to the mapped pixel points.

The point cloud data processing apparatus may further include an attribute interpolation unit as follows.

The attribute interpolation unit is configured to perform pixel point interpolation under the attribute channel on the depth image based on the attribute information corresponding to the mapped pixel points in the attribute channel, to obtain a pixel value of the interpolated pixel point under the attribute channel, the pixel value of the interpolated pixel point under the attribute channel representing attribute information of the target feature point that corresponds to the interpolated pixel point and that is in the three-dimensional scene.

The determining unit may be specifically configured to determine the target point cloud data at the second resolution based on the spatial position information and the attribute information of the target feature point, and the original point cloud data.

It may be learned from the foregoing that, in this embodiment, the obtaining unit 1001 may obtain original point cloud data at a first resolution, where the original point cloud data includes a plurality of feature points obtained by sampling a three-dimensional scene and spatial position information of the feature points and the spatial position information of the feature points represents spatial positions corresponding to the feature points in the three-dimensional scene; the mapping unit 1002 respectively maps, based on the spatial position information of the feature points in the original point cloud data, the feature points to mapped pixel points in a depth image at the first resolution, where pixel values of the mapped pixel points represent depth information of the mapped feature points; the interpolation unit 1003 performs interpolation on the depth image based on the depth information represented by the pixel values of the mapped pixel points in the depth image, to obtain an extended depth image at a second resolution; the position transformation unit 1004 performs spatial position transformation on an interpolated pixel point based on a pixel position of the interpolated pixel point in the extended depth image, to obtain spatial position information of a target feature point that corresponds to the interpolated pixel point and that is in the three-dimensional scene; and the determining unit 1005 determines target point cloud data at the second resolution based on the spatial position information of the target feature point and the original point cloud data.

In this application, point cloud data may be first converted into a corresponding depth image, interpolation is performed based on the depth image, and finally, a processed extended depth image is converted into high-resolution point cloud data. In this way, a resolution of point cloud data can be effectively improved, and obtained point distribution can fully describe a shape of an object, to improve accuracy of object detection. In addition, a large amount of training data is not needed, calculation complexity is low, and commonality and practicability are good.

An embodiment of this application further provides an electronic device. FIG. 11 is a schematic diagram of a structure of an electronic device according to an embodiment of this application. The electronic device may be a terminal or a server.

Specifically, the electronic device may include components such as a processor 1101 with one or more processing cores, a memory 1102 with one or more computer-readable storage media, a power supply 1103, and an input unit 1104. A person skilled in the art may understand that the structure of the electronic device shown in FIG. 11 does not constitute a limit to the electronic device, and may include more or fewer parts than those shown in the figure, may combine some parts, or may have different part arrangements.

The processor 1101 is a control center of the electronic device, is connected to various parts of the entire electronic device through various interfaces and lines, and implements various functions of the electronic device and processes data by running or executing a computer program and/or a module stored in the memory 1102 and invoking data stored in the memory 1102. In an embodiment, the processor 1101 may include one or more processing cores. Preferably, the processor 1101 may integrate an application processor and a modem processor. The application processor mainly processes an operating system, a user interface, an application, and the like. The modem processor mainly processes wireless communication. The foregoing modem processor may alternatively not be integrated into the processor 1101.

The memory 1102 may be configured to store a software program and a module. The processor 1101 runs the software program and the module stored in the memory 1102, to implement various functional applications and data processing. The memory 1102 may mainly include a program storage region and a data storage region. The program storage region may store an operating system, an application needed by at least one function (such as a sound playback function and an image display function), and the like. The data storage region may store data created based on use of the electronic device, and the like. In addition, the memory 1102 may include a high-speed random access memory, and may also include a non-volatile memory, for example, at least one magnetic disk storage device, a flash memory, or another volatile solid-state storage device. Correspondingly, the memory 1102 may further include a memory controller, to provide access of the processor 1101 to the memory 1102.

The electronic device further includes the power supply 1103 for supplying power to the components. Preferably, the power supply 1103 may logically connect to the processor 1101 through a power supply management system, to implement functions, such as charging, discharging, and power consumption management, by using the power supply management system. The power supply 1103 may further include one or more of a direct current or alternating current power supply, a re-charging system, a power failure detection circuit, a power supply converter or inverter, a power supply state indicator, and any other components.

The electronic device may further include the input unit 1104. The input unit 1104 may be configured to receive input information about number or character, and generate a keyboard, a mouse, a joystick, optical or trackball signal input related to user settings and function control.

Although not shown, the electronic device may further include a display unit, and the like. Details are not described herein again. Specifically, in this embodiment, the processor 1101 in the electronic device loads, according to the following instructions, executable file corresponding to processes of one or more applications into the memory 1102, and the processor 1101 runs the application programs stored in the memory 1102 to implement the following various functions:
obtaining original point cloud data at a first resolution, the original point cloud data including a plurality of feature points obtained by sampling a three-dimensional scene and spatial position information of the feature points, and the spatial position information of the feature points representing spatial positions corresponding to the feature points in the three-dimensional scene; respectively mapping, based on the spatial position information of the feature points in the original point cloud data, the feature points to mapped pixel points in a depth image at the first resolution, pixel values of the mapped pixel points representing depth information of the mapped feature points; performing interpolation on the depth image based on the depth information represented by the pixel values of the mapped pixel points in the depth image, to obtain an extended depth image at a second resolution; performing spatial position transformation on an interpolated pixel point based on a pixel position of the interpolated pixel point in the extended depth image, to obtain spatial position information of a target feature point that corresponds to the interpolated pixel point and that is in the three-dimensional scene; and determining target point cloud data at the second resolution based on the spatial position information of the target feature point and the original point cloud data.

For specific implementations of the foregoing operations, refer to the foregoing embodiments. Details are not described herein again.

It may be learned from the foregoing that, in this embodiment, original point cloud data at a first resolution may be obtained, where the original point cloud data includes a plurality of feature points obtained by sampling a three-dimensional scene and spatial position information of the feature points, and the spatial position information of the feature points represents spatial positions corresponding to the feature points in the three-dimensional scene; based on the spatial position information of the feature points in the original point cloud data, the feature points are respectively mapped to mapped pixel points in a depth image at the first resolution, where pixel values of the mapped pixel points represent depth information of the mapped feature points; interpolation is performed on the depth image based on the depth information represented by the pixel values of the mapped pixel points in the depth image, to obtain an extended depth image at a second resolution; spatial position transformation is performed on an interpolated pixel point based on a pixel position of the interpolated pixel point in the extended depth image, to obtain spatial position information of a target feature point that corresponds to the interpolated pixel point and that is in the three-dimensional scene; and target point cloud data at the second resolution is determined based on the spatial position information of the target feature point and the original point cloud data.

In this application, point cloud data may be first converted into a corresponding depth image, interpolation is performed based on the depth image, and finally, a processed extended depth image is converted into high-resolution point cloud data. In this way, a resolution of point cloud data can be effectively improved, and obtained point distribution can fully describe a shape of an object, to improve accuracy of object detection. In addition, a large amount of training data is not needed, calculation complexity is low, and commonality and practicability are good.

A person of ordinary skill in the art may understand that, all or some operations of various methods in embodiments may be implemented through instructions, or implemented through instructions controlling relevant hardware, and the instructions may be stored in the computer-readable storage medium and be loaded and executed by the processor.

Therefore, an embodiment of this application provides a non-transitory computer-readable storage medium having a plurality of instructions stored therein. The instructions can be loaded by a processor to perform operations in any point cloud data processing method provided in embodiments of this application. For example, the instructions may perform the following operations:
obtaining original point cloud data at a first resolution, the original point cloud data including a plurality of feature points obtained by sampling a three-dimensional scene and spatial position information of the feature points, and the spatial position information of the feature points representing spatial positions corresponding to the feature points in the three-dimensional scene; respectively mapping, based on the spatial position information of the feature points in the original point cloud data, the feature points to mapped pixel points in a depth image at the first resolution, pixel values of the mapped pixel points representing depth information of the mapped feature points; performing interpolation on the depth image based on the depth information represented by the pixel values of the mapped pixel points in the depth image, to obtain an extended depth image at a second resolution; performing spatial position transformation on an interpolated pixel point based on a pixel position of the interpolated pixel point in the extended depth image, to obtain spatial position information of a target feature point that corresponds to the interpolated pixel point and that is in the three-dimensional scene; and determining target point cloud data at the second resolution based on the spatial position information of the target feature point and the original point cloud data.

For specific implementations of the foregoing operations, refer to the foregoing embodiments. Details are not described herein again.

The computer-readable storage medium may include a read only memory (ROM), a random access memory (RAM), a magnetic disk, an optical disc, or the like.

Because the instructions stored in the computer-readable storage medium may implement the operations in any point cloud data processing method provided in embodiments of this application, the computer program can implement beneficial effects that may be implemented by any point cloud data processing method provided in embodiments of this application. For details, refer to the foregoing embodiments. Details are not described herein again.

According to one aspect of this application, a computer program product or a computer program is provided. The computer program product or the computer program includes computer instructions, and the computer instructions are stored in a non-transitory computer-readable storage medium. A processor of a computer device reads the computer instructions from the computer-readable storage medium. The processor executes the computer instructions to enable the computer device to implement the methods provided in various implementations of the above point cloud data processing aspect.

Technical features of the foregoing embodiments may be combined in different manners to form other embodiments. To make description concise, not all possible combinations of the technical features in the foregoing embodiments are described. However, the combinations of the technical features shall be considered as falling within the scope recorded by this description provided that no conflict exists.

In the embodiments of this application, a term “module” or “unit” refers to a computer program having a predetermined function or a part of a computer program, and operates together with other relevant parts to achieve a predetermined objective, and may be all or partially implemented by using software, hardware (such as a processing circuit or a memory), or a combination thereof. Similarly, one processor (or a plurality of processors or memories) may be configured to implement one or more modules or units. In addition, each module or unit may be a part of an overall module or unit including a function of the module or unit. The foregoing embodiments only describe several implementations of this application specifically and in detail, but cannot be construed as a limitation to the patent scope of this application. For a person of ordinary skill in the art, several transformations and improvements can be made without departing from the idea of this application. These transformations and improvements belong to the protection scope of this application. Therefore, the protection scope of the patent of this application shall be subject to the appended claims.

What is claimed is:

1. A method for processing point cloud data performed by an electronic device, the method comprising:
obtaining original point cloud data at a first resolution, the original point cloud data comprising a plurality of feature points obtained by sampling a three-dimensional scene and spatial position information of the feature points in the three-dimensional scene;
respectively mapping the feature points in the original point cloud data to pixel points in a depth image at the first resolution based on the spatial position information of the feature points, wherein pixel values of the mapped pixel points represents depth information of the feature points;
performing interpolation on the depth image based on the pixel values of the mapped pixel points in the depth image, to obtain an extended depth image at a second resolution;
performing spatial position transformation on interpolated pixel points in the extended depth image, to obtain spatial position information of target feature points in the three-dimensional scene that corresponds to the interpolated pixel point; and
determining target point cloud data at the second resolution based on the spatial position information of the target feature points and the original point cloud data.

2. The method according to claim 1, wherein the performing interpolation on the depth image based on the pixel values of the mapped pixel points in the depth image, to obtain an extended depth image at a second resolution comprises:
determining a to-be-interpolated pixel point in the depth image;
determining adjacent pixel points of the to-be-interpolated pixel point from the mapped pixel points in the depth image; and
fusing depth information of the adjacent pixel points to determine depth information of the to-be-interpolated pixel point at the second resolution.

3. The method according to claim 2, wherein the fusing depth information of the adjacent pixel points to determine depth information of the to-be-interpolated pixel point at the second resolution comprises:
determining pixel distances between the adjacent pixel points and the to-be-interpolated pixel point in the depth image;
determining weight information of the adjacent pixel points based on the corresponding pixel distances; and
fusing, based on the weight information, the depth information of the adjacent pixel points to determine the depth information of the to-be-interpolated pixel point.

4. The method according to claim 3, wherein the determining weight information of the adjacent pixel points based on the corresponding pixel distances comprises:
determining first weight information of the adjacent pixel points based on the corresponding pixel distances;
comparing the depth information of the adjacent pixel points with reference depth information, to determine relative depth information of the adjacent pixel points;
determining second weight information of the adjacent pixel points based on the relative depth information; and
fusing the first weight information and the second weight information, to obtain the weight information of the adjacent pixel points.

5. The method according to claim 1, wherein the performing spatial position transformation on interpolated pixel points in the extended depth image, to obtain spatial position information of target feature points in the three-dimensional scene that corresponds to the interpolated pixel point comprises:
determining, based on a pixel position of an interpolated pixel point in the extended depth image, a horizontal azimuth angle and a vertical angle that correspond to the interpolated pixel point; and
performing spatial position transformation on the interpolated pixel point based on the depth information, the horizontal azimuth angle, and the vertical angle that correspond to the interpolated pixel point, to obtain the spatial position information of a target feature point in the three-dimensional scene that corresponds to the interpolated pixel point.

6. The method according to claim 1, wherein the original point cloud data further comprises attribute information corresponding to the feature points, an image channel of the depth image comprises a depth channel and an attribute channel, pixel values of the mapped pixel points in the depth channel represent the depth information of the feature points corresponding to the mapped pixel points, and pixel values of the mapped pixel points in the attribute channel represent attribute information of the feature points corresponding to the mapped pixel points.

7. The method according to claim 6, wherein the method further comprises:
performing pixel point interpolation under the attribute channel on the depth image based on the attribute information corresponding to the mapped pixel points in the attribute channel, to obtain a pixel value of the interpolated pixel point under the attribute channel, the pixel value of the interpolated pixel point under the attribute channel representing attribute information of the target feature point that corresponds to the interpolated pixel point and that is in the three-dimensional scene; and
determining the target point cloud data at the second resolution based on the spatial position information and the attribute information of the target feature point, and the original point cloud data.

8. An electronic device, comprising a memory and a processor, the memory having an application stored therein, and the application, when executed by the processor, causing the processor to perform a method for processing point cloud data processing including:
obtaining original point cloud data at a first resolution, the original point cloud data comprising a plurality of feature points obtained by sampling a three-dimensional scene and spatial position information of the feature points in the three-dimensional scene;
respectively mapping the feature points in the original point cloud data to pixel points in a depth image at the first resolution based on the spatial position information of the feature points, wherein pixel values of the mapped pixel points represents depth information of the feature points;
performing interpolation on the depth image based on the pixel values of the mapped pixel points in the depth image, to obtain an extended depth image at a second resolution;
performing spatial position transformation on interpolated pixel points in the extended depth image, to obtain spatial position information of target feature points in the three-dimensional scene that corresponds to the interpolated pixel point; and
determining target point cloud data at the second resolution based on the spatial position information of the target feature points and the original point cloud data.

9. The electronic device according to claim 8, wherein the performing interpolation on the depth image based on the pixel values of the mapped pixel points in the depth image, to obtain an extended depth image at a second resolution comprises:
determining a to-be-interpolated pixel point in the depth image;
determining adjacent pixel points of the to-be-interpolated pixel point from the mapped pixel points in the depth image; and
fusing depth information of the adjacent pixel points to determine depth information of the to-be-interpolated pixel point at the second resolution.

10. The electronic device according to claim 9, wherein the fusing depth information of the adjacent pixel points to determine depth information of the to-be-interpolated pixel point at the second resolution comprises:
determining pixel distances between the adjacent pixel points and the to-be-interpolated pixel point in the depth image;
determining weight information of the adjacent pixel points based on the corresponding pixel distances; and
fusing, based on the weight information, the depth information of the adjacent pixel points to determine the depth information of the to-be-interpolated pixel point.

11. The electronic device according to claim 10, wherein the determining weight information of the adjacent pixel points based on the corresponding pixel distances comprises:
determining first weight information of the adjacent pixel points based on the corresponding pixel distances;
comparing the depth information of the adjacent pixel points with reference depth information, to determine relative depth information of the adjacent pixel points;
determining second weight information of the adjacent pixel points based on the relative depth information; and
fusing the first weight information and the second weight information, to obtain the weight information of the adjacent pixel points.

12. The electronic device according to claim 8, wherein the performing spatial position transformation on interpolated pixel points in the extended depth image, to obtain spatial position information of target feature points in the three-dimensional scene that corresponds to the interpolated pixel point comprises:
determining, based on a pixel position of an interpolated pixel point in the extended depth image, a horizontal azimuth angle and a vertical angle that correspond to the interpolated pixel point; and
performing spatial position transformation on the interpolated pixel point based on the depth information, the horizontal azimuth angle, and the vertical angle that correspond to the interpolated pixel point, to obtain the spatial position information of a target feature point in the three-dimensional scene that corresponds to the interpolated pixel point.

13. The electronic device according to claim 8, wherein the original point cloud data further comprises attribute information corresponding to the feature points, an image channel of the depth image comprises a depth channel and an attribute channel, pixel values of the mapped pixel points in the depth channel represent the depth information of the feature points corresponding to the mapped pixel points, and pixel values of the mapped pixel points in the attribute channel represent attribute information of the feature points corresponding to the mapped pixel points.

14. The electronic device according to claim 13, wherein the method further comprises:
performing pixel point interpolation under the attribute channel on the depth image based on the attribute information corresponding to the mapped pixel points in the attribute channel, to obtain a pixel value of the interpolated pixel point under the attribute channel, the pixel value of the interpolated pixel point under the attribute channel representing attribute information of the target feature point that corresponds to the interpolated pixel point and that is in the three-dimensional scene; and
determining the target point cloud data at the second resolution based on the spatial position information and the attribute information of the target feature point, and the original point cloud data.

15. A non-transitory computer-readable storage medium having a plurality of instructions stored thereon, the instructions, when executed by a processor of an electronic device, causing the electronic device to perform a method for processing point cloud data including:
obtaining original point cloud data at a first resolution, the original point cloud data comprising a plurality of feature points obtained by sampling a three-dimensional scene and spatial position information of the feature points in the three-dimensional scene;
respectively mapping the feature points in the original point cloud data to pixel points in a depth image at the first resolution based on the spatial position information of the feature points, wherein pixel values of the mapped pixel points represents depth information of the feature points;
performing interpolation on the depth image based on the pixel values of the mapped pixel points in the depth image, to obtain an extended depth image at a second resolution;
performing spatial position transformation on interpolated pixel points in the extended depth image, to obtain spatial position information of target feature points in the three-dimensional scene that corresponds to the interpolated pixel point; and
determining target point cloud data at the second resolution based on the spatial position information of the target feature points and the original point cloud data.

16. The non-transitory computer-readable storage medium according to claim 15, wherein the performing interpolation on the depth image based on the pixel values of the mapped pixel points in the depth image, to obtain an extended depth image at a second resolution comprises:
determining a to-be-interpolated pixel point in the depth image;
determining adjacent pixel points of the to-be-interpolated pixel point from the mapped pixel points in the depth image; and
fusing depth information of the adjacent pixel points to determine depth information of the to-be-interpolated pixel point at the second resolution.

17. The non-transitory computer-readable storage medium according to claim 16, wherein the fusing depth information of the adjacent pixel points to determine depth information of the to-be-interpolated pixel point at the second resolution comprises:
determining pixel distances between the adjacent pixel points and the to-be-interpolated pixel point in the depth image;
determining weight information of the adjacent pixel points based on the corresponding pixel distances; and
fusing, based on the weight information, the depth information of the adjacent pixel points to determine the depth information of the to-be-interpolated pixel point.

18. The non-transitory computer-readable storage medium according to claim 17, wherein the determining weight information of the adjacent pixel points based on the corresponding pixel distances comprises:
determining first weight information of the adjacent pixel points based on the corresponding pixel distances;
comparing the depth information of the adjacent pixel points with reference depth information, to determine relative depth information of the adjacent pixel points;
determining second weight information of the adjacent pixel points based on the relative depth information; and
fusing the first weight information and the second weight information, to obtain the weight information of the adjacent pixel points.

19. The non-transitory computer-readable storage medium according to claim 15, wherein the performing spatial position transformation on interpolated pixel points in the extended depth image, to obtain spatial position information of target feature points in the three-dimensional scene that corresponds to the interpolated pixel point comprises:
determining, based on a pixel position of an interpolated pixel point in the extended depth image, a horizontal azimuth angle and a vertical angle that correspond to the interpolated pixel point; and
performing spatial position transformation on the interpolated pixel point based on the depth information, the horizontal azimuth angle, and the vertical angle that correspond to the interpolated pixel point, to obtain the spatial position information of a target feature point in the three-dimensional scene that corresponds to the interpolated pixel point.

20. The non-transitory computer-readable storage medium according to claim 15, wherein the original point cloud data further comprises attribute information corresponding to the feature points, an image channel of the depth image comprises a depth channel and an attribute channel, pixel values of the mapped pixel points in the depth channel represent the depth information of the feature points corresponding to the mapped pixel points, and pixel values of the mapped pixel points in the attribute channel represent attribute information of the feature points corresponding to the mapped pixel points.
